(19) United States
(12) Patent Application Publication
(10) Pub. No.: US 2004/0156948 A1
(43) Pub. Date: Aug. 12, 2004

(54) Alkali metal bisulfate to acidify diet of infant or early stage animal

(76) Inventor: Bernard D. Murphy, Perrysburg, OH (US)

Correspondence Address: MACMILLAN SOBANSKI & TODD, LLC, ONE MARITIME PLAZA FOURTH FLOOR, 720 WATER STREET, TOLEDO, OH, 43604-1619, US

(21) Appl. No.: 10/774,196

(22) Filed: Feb. 6, 2004

Related U.S. Application Data
(60) Provisional application No. 60/445,984, filed on Feb. 7, 2003.

(51) Int. Cl. A01K 1/00

(52) U.S. Cl. 426/2

(57) ABSTRACT

An alkali metal bisulfate is included in a food for an infant or early stage animal. The alkali metal bisulfate is effective to increase the digestibility of the food. A preferred alkali metal bisulfate is sodium bisulfate.

### CROSS-REFERENCE TO RELATED APPLICATION

This application claims the benefit of U.S. provisional application serial No. 60/445,984, filed Feb. 7, 2003.

### BACKGROUND OF THE INVENTION

This invention relates in general to the diets of infant or early stage animals, and in particular to a method of increasing the digestibility of such diets.

Infant animals typically have trouble digesting an adult diet because their gastrointestinal systems are not adequately developed in terms of digestive and absorptive capabilities. For example, young piglets are usually unable to digest the cereal grains typically included in the diets of older pigs.

It is important to provide adequate nutrients to the infant animals to maintain their growth and health. To address the digestibility problem, infants are typically fed a highly-digestible, highly-nutritious liquid diet. These diets are usually relatively expensive compared to adult diets. Consequently, there is an incentive to begin feeding adult diets to the infant animals as soon as possible, particularly animals raised as livestock. However, if the infants are fed adult diets before their gastrointestinal systems are adequately developed, they may experience diarrhea and other health problems.

Various acids have been added to infant diets. For example, International Publication No. WO 89/08991, published Oct. 5, 1989, discloses a food for young animals, particularly piglets, to be administered during the first weeks of life. The food contains casein and whey proteins, gelatinized starch, vitamins, minerals, and organic acidifying compounds to maintain a low pH in the stomach. The acidifying compounds can be citric acid, lactic acid, or an acid obtained from Lactobacillus or other similar acid forming bacteria.

U.S. Pat. No. 4,857,338, issued Aug. 15, 1989, discloses a growth-promoting food for young pigs containing moisture, fat, protein, minerals, citric acid, calcium formate and lactose.

Peris et al., “Acidification and Other Physiological Additives”, CIHEAM-IAMZ, 2001, pp. 63-70, discloses that acidification of diets is crucial in young animals, which cannot secrete enough hydrochloric acid for correct protein digestion. It states that inorganic-based acidifiers are the most appropriate to achieve a regular digestion. The inorganic acids most commonly tested are hydrochloric, phosphoric and sulphuric acids. A dietary supplement for piglets is disclosed containing phosphoric acid, citric acid and fumaric acid.

Close, “Producing Pigs without Antibiotic Growth Promoters”, Advances in Pork Production (2000) Volume 11, pp. 47-56, discloses that both organic and inorganic acids have been included in pig diets. It states that the addition of acids lowers the pH and buffering capacity of the diet, reduces pH within the stomach, increases both gastric proteolysis and nutrient digestibility, and promotes beneficial bacteria at the expense of pathogenic organisms.

“Nursery Phase: Nutrition and Diet Management Concepts”, Nutrition Vol. 3, No. 1 (2003), discloses that water acidification is an effective means to prevent bacteria and fungi introduced from feed from multiplying in the piglet stomach. It also discloses that diets for the weaned pig are often supplemented with organic acids to reduce dietary pH and improve pig performance. The addition of organic acid (e.g., citric, fumaric, formic or mixtures) to starter feeds or water delivery systems has decreased gut edema and improved performance of early-weaned pigs.

There is still a need for an improved method of increasing the digestibility of the diets of infant and early stage animals.

### SUMMARY OF THE INVENTION

This invention relates to a method of increasing the digestibility of a food to an infant or early stage animal. The method comprises including in the food an alkali metal bisulfate in an amount effective to increase the digestibility of the food to the animal. A preferred alkali metal bisulfate is sodium bisulfate. Typically, the alkali metal bisulfate is included in the food in an amount between about 0.1% and about 5% by weight of the food.

Various advantages of this invention will become apparent to those skilled in the art from the following detailed description of the preferred embodiment.

### DETAILED DESCRIPTION OF THE PREFERRED EMBODIMENT

In the method of the invention, an alkali metal bisulfate is included in a food in an amount effective to increase the digestibility of the food to an infant or early stage animal. Preferably, the alkali metal bisulfate is sodium bisulfate, potassium bisulfate, or a mixture thereof. The sodium bisulfate is a sodium salt of sulfuric acid generally expressed as NaHSO₄ (CAS Reg. No. 7681-38-1). It is also known as sodium acid sulfate, sodium hydrogen sulfate, and bisulfate of soda.

A preferred sodium bisulfate for use in the invention is the food grade sodium acid sulfate manufactured by Jones-Hamilton Co., 30354 Tracy Road, Walbridge, Ohio 43465. It has been certified as GRAS and it meets Food Chemicals Codex, 4th Edition Specifications. It is a dry product comprising crystalline solid particles. The particles have a spherical shape with an average diameter of from about 0.03 mm to about 1 mm, typically about 0.75 mm. The product is hygroscopic and is readily soluble in water.

The Jones-Hamilton sodium acid sulfate is also preferred because it is a high quality product with low impurity levels. The product includes sodium bisulfate in an amount within a range of from about 91.5% to about 97.5% by weight (typically about 93%), and sodium sulfate in an amount within a range of from about 2.5% to about 8.5% by weight (typically about 7%). The product contains less than 0.003% heavy metals (typically less than 0.0004%), less than about 0.05% water insoluble substances (typically about 0.001%), and less than 0.003% selenium (all measured by weight percent).

The potassium bisulfate for use in the invention is a potassium salt of sulfuric acid generally expressed as KHSO₄ (CAS Reg. No. 7646-93-7). It is also known as potassium acid sulfate and potassium hydrogen sulfate.

Preferably, the alkali metal bisulfate is not more than mildly irritating to the skin, as indicated by a Primary Irritation Index of not more than 2. The method for measuring Primary Irritation Index is the well known “Draize grading” method disclosed in the journal article, Draize, J. H., Woodard, G., Calvery, H. O., “Methods for the Study of Irritation and Toxicity of Substances Applied Topically to the Skin and Mucous Membrane”, Journal of Pharmacology and Experimental Therapeutics, 1944, Vol. 82, pp. 377-390. The Primary Irritation Index values are calculated by averaging values for erythema (redness) on the skin of all subjects, averaging the values for edema (raised area caused by swelling) on the skin of all subjects, and combining the average values. The erythema and edema responses are scored as follows:

A. Erythema Formation:

1=Very slight erythema (barely perceptible)

2=Well defined erythema

3=Moderate to severe erythema

4=Severe erythema (beet redness)

Total possible erythema score: 4

B. Edema Formation:

1=Very slight edema (barely perceptible)

2=Slight edema (edges of area well defined by definite raising)

3=Moderate edema (area raised approximately 1 mm)

4=Severe edema (raised more than 1 mm and extending beyond area of exposure)

Total possible edema score: 4

Total possible score for Primary Irritation Index: 8

Agents producing Primary Irritation Index values of not more than 2 are considered only mildly irritating. Using this type of calculation, the Primary Irritation Index value for sodium acid sulfate is 0—the sodium acid sulfate is nonirritating to the skin.

The alkali metal bisulfate is acidic only in aqueous solution. In some embodiments of the invention, the food is in a dry form, and the alkali metal bisulfate is not dissolved until it is digested. In other preferred embodiment, the food includes enough moisture to dissolve the alkali metal bisulfate. The sodium acid sulfate is hygroscopic and will readily absorb moisture from the other food ingredients. Typically, the alkali metal bisulfate is included in the food in an amount between about 0.1% and about 5% by weight of the food, and more typically between about 0.1% and about 2%.

Advantageously, the use of the alkali metal bisulfate to increase the digestibility of the food provides a happy medium between the use of organic acids and the use of inorganic acids such as sulfuric acid and hydrochloric acid. Typical organic acids are weakly acidic, having a pKₐ of about 3-4. Alkali metal bisulfates are more strongly acidic than most organic acids; for example, sodium bisulfate has a pKₐ of about 1.9. As a result, significantly less alkali metal bisulfate is needed than organic acid to provide the improved digestibility. However, alkali metal bisulfates are less strongly acidic than inorganic acids such as sulfuric acid and hydrochloric acid, which usually have a pKₐ of less than 1. The strongly acidic inorganic acids may cause irritation to the gastrointestinal system and/or the skin of the animal, and they may cause undesirable effects on the food, such as hydrolysis, flocculation, dispersion, and color and emulsion instability. The alkali metal bisulfates are strong enough to increase the digestibility of the food, but mild enough to avoid irritation to the animal and undesirable effects on the food.

The method of the invention can be used to increase the digestibility of food to any type of infant or early stage animal (not including humans). The animal can be a production type (e.g., raised for meat, milk or fur, such as a pig or a bovine), a companion type (a pet such as a dog, a cat, or a horse), or a performance type (e.g., a race horse). For purposes of the invention, an infant pig is considered to be a piglet having an age not greater than about 8-10 weeks, an infant cow is considered to be a calf having an age not greater than about 4-6 months, and an infant horse is considered to be a colt having an age not greater than about 6 months.

The term “food” includes any type of solid, semi-solid or liquid food suitable for feeding to the animal. In addition to the alkali metal bisulfate, the food can contain any other ingredients suitable for use such foods. A piglet food may contain, for example, one or more ingredients selected from corn, soybeans, wheat, animal proteins, vitamins and minerals.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

1. A method of increasing the digestibility of a food to an infant or early stage animal comprising including in the food an alkali metal bisulfate in an amount effective to increase the digestibility of the food to the animal.

2. A method according to claim 1 wherein the alkali metal bisulfate is sodium bisulfate.

3. A method according to claim 1 wherein the animal is a piglet having an age not greater than about 10 weeks.

4. A method according to claim 1 wherein the alkali metal bisulfate is included in the food in an amount between about 0.1% and about 5% by weight of the food.

5. A method according to claim 1 wherein the food includes moisture in an amount effective to dissolve the alkali metal bisulfate.

6. A method according to claim 1 wherein the alkali metal bisulfate is sodium bisulfate containing less than 0.003% heavy metals, less than 0.05% water insoluble substances and less than 0.003% selenium by weight.

7. A method according to claim 1 wherein the alkali metal bisulfate is sodium bisulfate added as a product consisting essentially of from about 91.5% to about 95.5% sodium bisulfate and from about 4.5% to about 8.5% sodium sulfate, by weight.
